(19) United States
(12) Patent Application Publication
(10) Pub. No.: US 2007/0043185 A1
(43) Pub. Date: Feb. 22, 2007

(54) Polymerization process

(76) Inventors: Gregory R. Alms, Hockessin, DE (US); Edward G. Brugel, Wilmington, DE (US); Richard Alan Jackson, Hockessin, DE (US); Michael Robert Samuels, Wilmington, DE (US); Marion G. Waggoner, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/448,474

(22) Filed: Jun. 7, 2006

Related U.S. Application Data
(60) Provisional application No. 60/688,749, filed on Jun. 8, 2005.

(51) Int. Cl. C08F 4/44

(52) U.S. Cl. 526/160

(57) ABSTRACT

A process for the production of polymers in which an oligomeric precursor is formed first in a melt phase. A phase transition is then induced in the polymerizing reaction medium under the action of shear in such a way that the simultaneous action of the shear, and the ongoing polymerization through the phase transition produces a product that is in a powdered form.

### CROSS REFERENCE TO RELATED APPLICATIONS

This application claims the benefit of priority to U.S. Provisional Application No. 60/689,749, filed Jun. 8, 2005.

### FIELD OF THE INVENTION

The present invention relates to a process for the polymerization of condensation polymers such as polyamides and polyesters.

### BACKGROUND OF THE INVENTION

Conventional techniques for polymerization may employ a solution or slurry of ingredients. For example, polymerization of diacid and diamine reactant mixtures to form polyamide is accomplished by the gradual removal of the water from the reactant mixture at elevated pressures by the continuous application of heat (and a consequent increase in the temperature of the reaction medium). In this manner the majority of the water is removed.

The reaction paths for solution polymerizations—defined as combinations of temperature and pressure conditions either in time for a batch process or at different reaction zones for a continuous process—are conventionally chosen in such a way that the reaction mixture is maintained in a liquid phase. This requirement to avoid any liquid-solid phase separation usually implies operating at significantly elevated pressures and correspondingly high temperatures in order to remove the water from the reaction mixture during the early stages of the polymerization, usually in excess of 300 to 400 psig for reaction mixtures containing terephthalic acid, such as PA-6T/66. Furthermore, removal of the remaining water in the later stages of polymerization by gradual reduction of pressure and increasing temperature above the melting point of the polymer requires relatively long times due to heat and mass transfer limitations. One disadvantage of polymerization under these conditions is the resultant high degree of degradation reactions and products which diminishes the usefulness of the final polymer product.

Conventional techniques such as those described above and associated with the polymerization and formation of polyamides, polyesters, and other condensation polymers have a number of constraints. Of significant interest, the process for conversion of the monomers to low molecular weight polymer is only accomplished by operating at conditions of pressure, temperature and polymer concentration in water corresponding to the single phase region outside the solid polymer melting phase boundary.

Those of skill in the art therefore typically conduct early stage polymerization of polyamide systems based upon, for example, terephthalic acid, at elevated conditions of pressure and temperature so that the reaction proceeds above the solid polymer melting phase boundary. See for example, JP 7138366. Alternatively, for the production of higher molecular weight polymers, two step semi-continuous processes have been employed for the polymerization of these polymers. Such approaches first require the formation of a low molecular weight polymer at high pressures and temperatures and later isolated either in solid or liquid form from the early stages of the polymerization. For example, U.S. Pat. No. 4,762,910 to Bayer, hereby incorporated herein by reference in its entirety, describes a process for making copolymers of adipic acid, terephthalic acid and hexamethylene diamine (HMD) by first preparing a precondensate of the monomers and then further condensing the precondensate.

Further molecular weight build-up in such processes can also be achieved, for example, through subsequent processing using operating conditions which allow for rapid heating of the low molecular weight polymer above its melting point in high shear fields and generation of mechanical heat, like twin screw extruders.

There are numerous deleterious consequences in choosing to operate at conditions of elevated temperatures and pressure early in the polymerization. Most particularly, high temperatures prompt the early inception of degradation reactions, which have the effect of diminishing the usefulness of the final polymer product. An example is the amidine branching equilibrium associated with polymerization involving aromatic diacids. Further, the influence of pressure on fluid physical properties such as vapor phase density and vapor/liquid interfacial tension may be detrimental to achieving good heat transfer performance. Moreover, such approaches have additional production costs associated with the isolation and re-melt of the oligomer for the two step process, and pose challenges in the handling of powders. Even if the oligomer is kept in molten form there are a number of difficulties in limiting the degradation and contamination of materials, typically associated with oligomer-vapor separation chambers run at excessively high temperatures.

There is a need for a process for the production of polymers in general and polyamides in particular that avoids the longstanding requirement to operate at conditions in which deleterious polymerization side reactions, and with their attendant adverse heat and mass transfer physics, are associated—even just in the early stages of polymerization reactions. With such a process, product of enhanced quality will be obtained. Improvements in capital costs and operating productivity are also benefits to such a process. An example of such a process is disclosed in commonly assigned U.S. Pat. No. 6,759,505, incorporated herein in its entirety by reference. In the '505 patent is disclosed a process in which the reaction mixture is in a thermodynamic state that would yield multiple phases, except that the reaction mixture is kept in a metastable state by running the reaction at pressures and for times that avoid phase separation.

The object of the present invention is a process for the production of polymers in a way that avoids the limitations of the '505 patent but retains the advantages of lower temperatures than are possible with the thermodynamically stable single phase system.

### BRIEF DESCRIPTION OF THE INVENTION

The present invention is related to the manufacture of polymers with improved properties relative to polymers made by processes currently known in the art.

The present inventors have discovered that it is possible to avoid the limitations on process conditions imposed by the process of '505, and retain the advantages of the lower temperature reaction conditions, by running the reaction under conditions of shear and temperature that yield a multiphase reaction mixture.

In one embodiment of the invention a reactant mixture comprising one or more monomers and optionally other ingredients such as solvents and chain modifying agents, is charged into a reactor. The reactant mixture is brought to a required temperature and pressure and held under conditions of temperature and pressure that monomers form an oligomeric precursor to the required product polymer. The reactant system is then optionally cooled and/or the pressure is reduced, and held under this condition(s) such that a phase transition takes place to form a multiphase system that comprises polymer. As polymerization progresses, polymer displaces monomer and oligomeric precursor. Water, other by-products, and excess reactants are removed and a polymeric powder is formed under the conditions of shear that exist in the reactor. Polymerization can optionally be continued in the solid phase if a higher molecular weight product is required.

In a second embodiment of the invention an oligomeric precursor is formed in a first reactor under conventional reaction conditions. A reaction mixture that comprises oligomeric precursor and optionally other components is then supplied to a second reactor. Conditions of shear, pressure, and temperature in the second reactor are such that the oligomeric precursor continues to polymerize to form polymer that then precipitates in a solid state as a powder. The powder is discharged from the reactor in a subsequent step. As above further polymerization can optionally be continued in the solid phase if a higher molecular weight product is required. For some polymerizations, it may be possible to use the same vessel for the first and second reactors, eliminating the need to discharge the first reactor.

### BRIEF DESCRIPTION OF THE DRAWINGS

FIG. 1 shows a schematic representation of traces of molecular weight versus time and temperature vs. time for a molten phase polymerization reaction.

FIG. 2 shows a schematic representation of traces of molecular weight versus time and temperature vs. time for a phase transition polymerization reaction of the present invention.

### DETAILED DESCRIPTION OF THE INVENTION

### Definitions

By “oligomeric precursor” is meant a polymeric species that has a molecular weight that is lower than the molecular weight of the final desired polymer product of the process. The polymer produced during the process of the invention from the oligomeric precursors can be further condensed in situ, for example in a solid phase polymerization, or discharged from the reactor and subsequently processed in a further polymerization step.

The word “essentially” as used in the context of this invention means “to the extent of greater than 50%”.

A “monomer” means any substance or compound that can be converted to a polymer by the application of suitable conditions of heat, pressure and shear. The monomer may optionally require an initiator or other monomers for the polymerization reaction to take place.

### Description of the Process

The process of the present invention entails subjecting a molten oligomeric precursor plus any required additives to conditions that cause it to further polymerize (not necessary for the polymerization to continue) while undergoing a phase transition from a liquid phase to essentially a solid state while being subjected to shearing that is intense enough to produce a polymer disperson and then powdered product. Powder particles are formed from the confluence of the shearing action and solid formation during the phase transition and further polymerization can optionally be allowed to take place in the solid powder. The reaction vessel can also be charged with any additives or fillers that may be necessary to produce the final product.

The process takes place in a reactor that is capable of applying heat and shear to the reaction mixture. In one embodiment of the invention, one or more monomers and other optional ingredients are charged into the reactor and the reaction mixture is brought to a temperature sufficient to produce an oligomeric precursor. The reactant system is then optionally cooled and/or pressure is reduced, and held under this condition(s) such that a phase transition takes place to form a multiphase system that comprises polymer. The shear action in the reactor ensures that the polymer that is formed is in a dispersed form. As polymerization progresses and polymer displaces monomer and oligomeric precursor, water is removed and a polymeric powder is formed under the conditions of shear that exist in the reactor. Polymerization can optionally be continued in the solid phase if a higher molecular weight product is required.

In a further embodiment of the reaction, conventional polymerization equipment can be used to produce an oligomeric precursor that can then be fed directly to a high shear reactor, or cooled and pelletized or powdered and reheated and fed to the polymerization reactor.

In one embodiment of the invention the reactor is a plough mixer, for example the Lodige Ploughshare Mixer (Lodige, Paderborn, Germany), or the plow reactor manufactured by Littleford Day (Cincinnati, Ohio). However any mixer or agitator that is capable of producing a flowable powder from the reactants after reaction is suitable for the process.

Transition from the liquid phase oligomeric precursor to the solid phase polymer may be achieved by adjusting the pressure and/or temperature in the polymerization reactor. The change in temperature and/or pressure may be accomplished by changing the system temperature through external heating or cooling or the addition of coolant gas or liquid to the system, applying vacuum or through a combination of any or all these steps. One skilled in the art will be able to accomplish control of the process in this way without undue experimentation. Solid state polymerization is then optionally performed in the high shear reactor or some other reactor suitable for solid state polymerization at a pressure and temperature that are below the melting temperature of the solid precursor contained in the reactor.

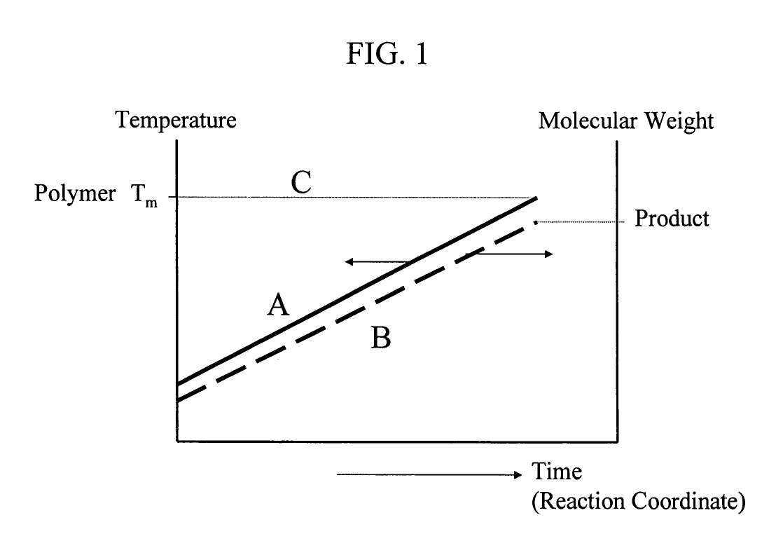

The process of the invention can be further understood by reference to the figures. In FIG. 1 is shown traces on the same graph of a schematic representation of the reaction temperature and the molecular weight of the product for a conventional polymerization that is carried out in the melt phase of the polymer being formed. The system does not have to be a single phase, and other solvents or additives can be present, however the polymer that is being formed in the reaction is essentially molten for the duration of the reaction time until the system is cooled and solid polymer end product is discharged from the reaction vessel.

Line A in FIG. 1 represents the reaction temperature as time progresses, and line B represents the molecular weight of the product being formed as the reaction progresses. The reaction temperature must essentially track the molecular weight of the product as water or other by-products such as methanol or acetic acid are being lost from the reactor and the polymer is being formed. The reactant mixture comprises polymer, prepolymeric species and water. When the final product polymer is formed it has a melt temperature denoted by Tₘ on FIG. 1.

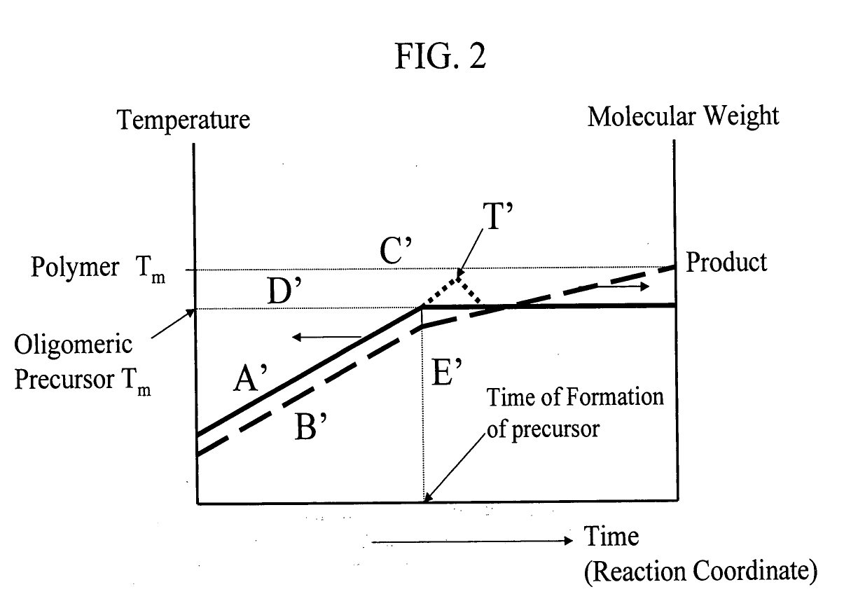

In FIG. 2 is shown an equivalent trace for one embodiment of the process of the invention. Lines A′ and B′ represent the temperature and molecular weight lines respectively. Line C′ represents the melt temperature of the final product, denoted “polymer Tₘ” on the figure. At a reaction temperature equivalent to line D′ on FIG. 2, the reaction temperature denoted “Oligomeric Precursor Tₘ” on the figure is such that the system is in a liquid phase comprising oligomeric precursor. The reaction temperature is then optionally allowed to raise to point T′ by means of temperature controls on the reaction vessel at this temperature for the duration of the reaction. Alternatively, the reaction medium can simply be held at the temperature “Oligomeric Precursor Tₘ” for the duration of the polymerization reaction. This temperature control is shown by the discontinuity on line A′ in FIG. 2. During the period following the time of formation of precursor, continued growth of the oligomer into polymer occurs. The polymerization continues in the multiphase system that comprises oligomeric precursor in a liquid phase and solid polymer.

Although in FIG. 2 the polymer growth rate is depicted as dropping, the invention is not limited to such a case and it is possible that growth rate increases or stays constant. The reaction is then allowed to continue until the required degree of polymerization is achieved.

FIG. 2 is intended to be illustrative only and the scope of the invention is to be in no way limited thereby. Although the reaction temperature in FIG. 2 is shown as remaining constant after formation of oligomeric precursor, any temperature profile that produces polymer within the dynamic multiphase system that exists to the right of line E′ in FIG. 2 is within the scope of the disclosure and claims of the invention.

Similarly the exact locus of the polymerization reaction is not important to the scope for the claims listed herein, and the polymerization reaction may be taking place in any of the phases that exist in the reaction mixture.

The reaction depicted in FIG. 2 does not have to take place in one reactor. For example the reaction mixture at the point where oligomeric precursor is formed can be discharged from the vessel where it is manufactured into a second vessel for the reaction to continue. Similarly, once a polymer powder has been formed, the reaction mixture is essentially in the sold phase, and can be allowed to continue therein until a product of the desired molecular weight is formed. The oligomeric precursor can also be charged directly to the reactor, melted and the reaction allowed to progress as polymer powder is formed from the molten oligomer phase.

The entire reaction shown in FIG. 2 is carried out with a shear profile that must supply enough agitation to the reaction mixture to ensure that as the multiphase system develops after time E′, the polymer solid is dispersed into a powder at the conclusion of the reaction.

No particular limitation is imposed on the condensation polymers that can be manufactured by the process of the invention. Examples of the thermoplastic resins include aromatic polyesters such as poly(ethylene terephthalate), poly(butylene terephthalate), poly(propylene terephthalate), poly(1,4-cyclohexylene dimethylene terephthalate), poly(ethylene naphthalate), and poly(butylene naphthalate); polyacetals (homopolymer and copolymer); polyester-based thermoplastic elastomers, polyamide-based thermoplastic elastomers, and polyether-based thermoplastic elastomers; polyacrylate-based, core-shell type, multi-layered graft copolymers; and modified products thereof. These thermoplastic resins may be used in combination of two or more species.

Examples of monomers suitable for use in the process of the present invention to make polyesters include aromatic dicarboxylic acids (and/or their carboxylic acid derivatives such as esters) having 8 to 14 carbon atoms and at least one diol. Preferred diols are aliphatic and alicyclic diols such as neopentyl glycol; cyclohexanedimethanol; 2,2-dimethyl-1,3-propane diol; and aliphatic glycols of the formula HO(CH₂)ₙOH where n is an integer of 2 to 10. Preferred diols include ethylene glycol; 1,4-butanediol; 1,3-propanediol; 1,6-hexandiol; and 1,4-cyclohexanedimethanol. Difunctional hydroxy acid monomers such as hydroxybenzoic acid or hydroxynaphthoic acid or their reactive equivalents may also be used. Preferred aromatic dicarboxylic acids and acid derivatives include terephthalic acid and dimethyl terephthalate.

Examples of monomers that can be used in the process of the invention are, with meaning to be limited thereby, diacids such as adipic, glutaric, suberic, sebacic, dodecanedioic, isophthalic, terephthalic, azelaic and pimelic acids, and diamines such as hexamethylenediamine, heptamethylenediamine, octamethylenediamine, nonamethylenediamine, decamethylenediamine, 2-methylpentamethylenediamine, undecamethylenediamine, dodecamethylenediamine and xylylenediamine.

Polycarbonates can be manufactured by the process of the invention and examples of monomer moieties that can be used are bisphenols having structure exemplified by by bisphenol A; 2,2-bis(4-hydroxy-3-methylphenyl)propane; 2,2-bis(3-chloro-4-hydroxyphenyl)propane; 2,2-bis(3-bromo-4-hydroxyphenyl)propane; 2,2-bis(4-hydroxy-3-isopropylphenyl)propane; 1,1-bis(4-hydroxyphenyl)cyclohexane; 1,1-bis(4-hydroxy-3-methylphenyl)cyclohexane; and 1,1-bis(4-hydroxyphenyl)-3,3,5-trimethylcyclohexane and the like.

Some illustrative, non-limiting examples of aromatic dihydroxy comonomer compounds include the dihydroxy-substituted aromatic hydrocarbons disclosed by name or formula (generic or specific) in U.S. Pat. No. 4,217,438. Some particular examples of aromatic dihydroxy compound comonomers include 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2)-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane (commonly known as bisphenol A); 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 2,2-bis(3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; 2,6-dihydroxy naphthalene; hydroquinone; resorcinol; and C.sub.1-3 alkyl-substituted resorcinols.

Diaryl carbonates suitable for use in the invention are illustrated by diphenyl carbonate, bis(4-methylphenyl)carbonate, bis(4-chlorophenyl)carbonate, bis(4-fluorophenyl)carbonate, bis(2-chlorophenyl)carbonate, bis(2,4-difluorophenyl)carbonate, bis(4-nitrophenyl)carbonate, bis(2-nitrophenyl)carbonate, bis(methyl salicyl)carbonate, and the like.

Melt transesterification polymerization can be implemented in the process, wherein a monomer may be a carbonic acid diester is selected from the group consisting of diaryl carbonates, dialkyl carbonates, mixed aryl-alkyl carbonates, diphenyl carbonate, bis(2,4dichlorophenyl) carbonate, bis(2,4,5-trichlorophenyl)carbonate, bis(2-cyanophenyl) carbonate, bis(o-nitrophenyl)carbonate, (o-carbomethoxyphenyl)carbonate; (o-carboethoxyphenyl)carbonate, ditolyl carbonate, m-cresyl carbonate, dinaphthyl carbonate, di(biphenyl)carbonate, diethyl carbonate, dimethyl carbonate, dibutyl carbonate, dicyclohexyl carbonate, and combinations comprising at least one of the foregoing carbonic acid diesters.

Liquid crystalline polyesters can be prepared by the method of the invention. Examples of preferred monomers for preparing the liquid crystalline polyester of the present invention include

(i) naphthalene compounds such as 2,6-naphthalenedicarboxylic acid, 2,6-dihydroxynaphthalene, 1,4-dihydroxynaphthalene, and 6-hydroxy-2-naphthoic acid;

(ii) biphenyl compounds such as 4,4′-diphenyldicarboxylic acid and 4,4-dihydroxybiphenyl;

(iii) p-substituted benzene compounds such as p-hydroxybenzoic acid, terephthalic acid, hydroquinone, p-aminophenol, and p-phenylenediamine, and nucleus-substituted benzene compounds thereof (nucleus substituents being selected from chlorine, bromine, a C1-C4 alkyl, phenyl, and 1-phenylethyl); and

(iv) m-substituted benzene compounds such as isophthalic acid and resorcin, and nucleus-substituted benzene compounds thereof (nucleus substituents being selected from chlorine, bromine, a C1-C4 alkyl, phenyl, and 1-phenylethyl).

Among the aforementioned monomers, liquid crystalline polyesters prepared from at least one or more species selected from among naphthalene compounds, biphenyl compounds, and p-substituted benzene compounds are more preferred as the liquid crystalline polyester of the present invention.

Among the p-substituted benzene compounds, p-hydroxybenzoic acid, methylhydroquinone, and 1-phenylethylhydroquinone are particularly preferred.

In addition to the aforementioned monomers, the liquid crystalline polyester of the present invention may contain, in a single molecular chain thereof, a polyalkylene tetrphthalate fragment which does not exhibit an anisotropic molten phase. In this case, the alkyl group has 2-4 carbon atoms.

Specific examples of compounds having an ester-formable functional group and those of liquid crystalline polyesters that can be produced by the method of the present invention are disclosed in Japanese Patent Publication (kokoku) No. 63-36633.

Substances or additives which may be added to the polymer or oligomeric precursor of this invention, include, but are not limited to, heat-resistant stabilizers, UV absorbers, mold-release agents, antistatic agents, slip agents, antiblocking agents, lubricants, anticlouding agents, coloring agents, natural oils, synthetic oils, waxes, organic fillers, inorganic fillers, and mixtures thereof.

Examples of the aforementioned heat-resistant stabilizers, include, but are not limited to, phenol stabilizers, organic thioether stabilizers, organic phosphite stabilizers, hindered amine stabilizers, epoxy stabilizers and mixtures thereof. The heat-resistant stabilizer may be added in the form of a solid or liquid.

Examples of UV absorbers include, but are not limited to, salicylic acid UV absorbers, benzophenone UV absorbers, benzotriazole UV absorbers, cyanoacrylate UV absorbers, and mixtures thereof.

Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylenebisstearamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acid, polyhydric alcohol esters of fatty acid, polyglycol esters of fatty acid, and other fatty acid ester mold release agents; silicone oil and other silicone mold release agents, and mixtures of any of the aforementioned.

The coloring agent may be either pigments or dyes. Inorganic coloring agents and organic coloring agents may be used separately or in combination the invention.

### EXAMPLES

The process of the invention can be further understood by consideration of the following examples.

In the following examples inherent viscosity (IV) of the polyamide samples was measured in m-cresol solvent at 25 C and a concentration of 0.5 g polymer in 100 ml solvent

### Example 1

A reactor equipped with a plow mixer (Littleford Day, Cincinnati Ohio) was charged with 20.68 kg (calculated ad pure HMD) of hexamethylene diamine (HMD at 80% in water), 59.09 kg of demineralized water and 25.95 kg of adipic acid and heated to 70° C. with gentle agitation for 60 minutes, following which the pH was adjusted to 8.14 with adipic acid. The temperature was then raised until the temperature of the reaction mixture was 195° C. and 190 psia as the reaction mixture concentrated, and then a phase transition was initiated by slowly lowering pressure to atmospheric while maintaining temperature. The product was then cooled to 180° C. when the product was allowed to polymerize in the solid phase for 36 minutes. The mixture was then cooled to below 100° C. and a white powder of IV=0.52 was discharged.

### Example 2

The reaction of example 1 was repeated, with 24.88 kg of adipic acid and 19.83 kg (calculated as pure HMD) of HMD solution. Following the oligomer forming reaction, the reaction temperature was reduced to 180° C. and the polymerization reaction was allowed to continue in the solid phase for 1.5 hours after which the IV of the polymer was 1.19 after cooling and discharge.

### Example 3

The reaction of example 2 was repeated with the exception that the pH of the reaction mixture was 8.6, and the reaction was allowed to continue in the solid phase for 4 hours after which the IV of the discharged powder was 1.49.

### Example 4

The reaction of example 1 was repeated except that the initial ingredients charged in the reactor were 28.3 kg HMD in 80% solution on water, 13.34 kg adipic acid, 17.22 kg of terephthalic acid and 12.05 kg of demineralized water. The reaction mixture was allowed to concentrate up to a temperature of 200° C. and was kept at 200° C. for the polymerization. The polymerization was allowed to continue for 50 minutes at 200° C. and then the temperature was raised over 150 minutes to 250° C. and then dropped to below 100° C. over another 100 minutes. A white powder with an IV of 0.87 was discharged. The level of bishexamethylenetriamine (BHMT) in the product was determined as a marker of by product formation in the product by hydrolysis and gas chromatography of the hydrolysate and compared with a control polymer made by a conventional process. The product of the present invention contained 6.14 meq/kg of BHMT. The control material contained 15.4 meq/kg.

### Example 5

A reactor of total volume 4 liters and equipped with a high speed blade mixer was charged with 1.82 kg of a polybutylene terephthalate oligomer of IV=0.15. The oligomer was melted and brought to a temperature of 230° C. over a 150 minute period and then cooled to 140° C. and brought back to the polymerization temperature of 200° C. for 307 minutes. The reaction mixture was cooled and a white powder of IV=0.70 obtained.

The invention has been described in detail herein with particular reference to examples and preferred embodiments thereof, but it will be understood by those skilled in the art that variations and modifications can be effected within the spirit and scope of the invention.

We claim:

1. A process for the production of a polymer comprising the steps of;
i) providing an oligomeric precursor in a liquid phase in a reaction vessel, optionally with other compounds,
ii) subjecting the oligomeric precursor while it is in the liquid phase to a shear action and to a temperature while polymerization of the of the oligomeric precursor occurs to form a solid phase polymer dispersed in the liquid phase, and for a sufficient time that the polymer is of a required molecular weight,
iii) optionally continuing the polymerization in the solid phase,
iv) discharging the polymer from the reaction vessel,
in which the temperature and shear action that are applied to the oligomeric precursor melt in step (ii) are maintained such that the polymer discharged in step (iv) is essentially in a powder form.

2. The process of claim 1 in which the shear action in step ii) is provided by a plough mixer.

3. The process of claim 1 in which the oligomeric precursor comprises a material selected form the group consisting of polyethylene terephthalate, polybutylene terephthalate, polyethylene naphthalate, polybutylene naphthalate, homopolymer polyacetals, copoymer polyacetals, condensation polymers of a diacid and a diamine, polyester-based thermoplastic elastomers, polyamide-based thermoplastic elastomers, polyether-based thermoplastic elastomers, and blends and modified products thereof.

4. A process for the production of a polymer comprising the steps of;
i) providing a reactant mixture in a reaction vessel,
ii) bringing the reactant mixture to conditions of temperature and pressure such that reaction takes place to form oligomeric precursor that is essentially in a molten state,
iii) subjecting the oligomeric precursor while it is in the liquid phase to a shear action and to a temperature while polymerization of the of the oligomeric precursor occurs to form a solid phase polymer dispersed in the liquid phase, and for a sufficient time that the polymer is of a required molecular weight,
iv) optionally continuing the polymerization in the solid phase,
v) discharging the polymer from the reaction vessel,
in which the reactant mixture comprises one or more monomers, and the temperature and shear action that are applied to the oligomeric precursor melt in step iii) are maintained such that the polymer discharged in step (iv) is essentially in a powder form.

5. The process of claim 4, wherein the monomers comprise one or more diacids and one or more diamines.

6. The process of claim 5, wherein the diamines are selected from the group consisting of hexamethylenediamine, heptamethylenediamine, octamethylenediamine, nonamethylenediamine, decamethylenediamine, 2-methylpentamethylenediamine, undecamethylenediamine, dodecamethylenediamine and xylylenediamine.

7. The process of claim 5 in which the diacids are selected from the group consisting of adipic, glutaric, suberic, sebacic, dodecanedioic, isophthalic, terephthalic, azelaic and pimelic acids.

8. The process of claim 4 in which the monomers comprise one or more bisphenols.

9. The process of claim 9 in which the bisphenol is selected from the group bisphenol A, 2,2-bis(4-hydroxy-3-methylphenyl)propane, 2,2-bis(3-chloro-4-hydroxyphenyl)propane, 2,2-bis(3-bromo-4-hydroxyphenyl)propane, 2,2-bis(4-hydroxy-3-isopropylphenyl)propane, 1,1-bis(4-hydroxyphenyl)cyclohexane, 1,1-bis(4-hydroxy-3-methylphenyl)cyclohexane, and 1,1-bis(4-hydroxyphenyl)-3,3,5-trimethylcyclohexane.

10. The process of claim 5 in which the monomers comprise one or more diesters of dicarboxylic acids.

11. The process of claim 10 in which the diester is selected from the group consisting of diaryl carbonates, dialkyl carbonates, mixed aryl-alkyl carbonates, diphenyl carbonate, bis(2,4dichlorophenyl) carbonate, bis(2,4,5-trichlorophenyl) carbonate, bis(2-cyanophenyl) carbonate, bis(o-nitrophenyl) carbonate, (o-carbomethoxyphenyl)carbonate; (o-carboethoxyphenyl)carbonate, ditolyl carbonate, m-cresyl carbonate, dinaphthyl carbonate, di(biphenyl) carbonate, diethyl carbonate, dimethyl carbonate, dibutyl carbonate, dicyclohexyl carbonate, and combinations thereof.

12. The process of claim 4 in which the monomers comprise one or more aliphatic and/or aromatic dihydroxy compounds.

13. The process of claim 12 in which the aromatic dihydroxy compounds compounds include compounds selected from the group consisting of 4,4′-(3,3,5-trimethylcyclohexylidene)diphenol, 4,4′-bis(3,5-dimethyl)diphenol, 1,1-bis(4-hydroxy-3-methylphenyl)cyclohexane, 4,4-bis(4-hydroxyphenyl)heptane, 2,4′-dihydroxydiphenylmethane, bis(2-hydroxyphenyl)methane, bis(4-hydroxyphenyl)methane, bis(4-hydroxy-5-nitrophenyl)methane, bis(4-hydroxy-2,6-dimethyl-3-methoxyphenyl)methane, 1,1-bis(4-hydroxyphenyl)ethane, 1,1-bis(4-hydroxy-2-chlorophenyl)ethane, 2,2-bis(4-hydroxyphenyl)propane (commonly known as bisphenol A), 2,2-bis(3-phenyl-4-hydroxyphenyl)propane, 2,2-bis(4-hydroxy-3-methylphenyl)propane, 2,2-bis(4-hydroxy-3-ethylphenyl)propane, 2,2-bis(4-hydroxy-3-isopropylphenyl)propane, 2,2-bis(4-hydroxy-3,5-dimethylphenyl)propane, 2,2-bis(3,5,3′,5′-tetrachloro4,4′-dihydroxyphenyl)propane, bis(4-hydroxyphenyl)cyclohexylmethane, 2,2-bis(4-hydroxyphenyl)-1-phenylpropane, 2,4′-dihydroxyphenyl sulfone, 2,6-dihydroxy naphthalene, hydroquinone, resorcinol, C1 to C3 alkyl-substituted resorcinols, and blends or mixtures of the preceding.

14. The process of claim 4 in which the monomers comprise at least one aromatic dicarboxylic acid or carboxylic acid derivative and at least one diol.

15. The process of claim 14 in which the aromatic dicarboxylic acid or carboxylic acid derivative is terephthalic acid/or and dimethyl terephthalate and the diol is one or more of neopentyl glycol; cyclohexanedimethanol; 2,2-dimethyl-1,3-propane diol; and aliphatic glycols of the formula HO(CH₂)ₙOH where n is an integer of 2 to 10.

16. The process of claim 15 in which the aromatic dicarboxylic acid or carboxylic acid derivative is terephthalic acid/or and dimethyl terephthalate and the diol is one or more of ethylene glycol; 1,4-butanediol; 1,3-propanediol; 1,6-hexandiol; and 1,4-cyclohexanedimethanol.
